(19) United States
(12) Patent Application Publication
(10) Pub. No.: US 2015/0205422 A1
(43) Pub. Date: Jul. 23, 2015

(54) TOUCH SENSOR

(71) Applicant: SAMSUNG ELECTRO-MECHANICS CO., LTD., Gyeonggi-Do (KR)

(72) Inventors: Young An CHOI, Gyeonggi-Do (KR); Kyoung Soo CHAE, Gyeonggi-Do (KR); Seung Hoon HAN, Gyeonggi-Do (KR); Gwan Ha JEONG, Gyeonggi-Do (KR)

(73) Assignee: SAMSUNG ELECTRO-MECHANICS CO., LTD., Gyeonggi-Do (KR)

(21) Appl. No.: 14/300,738

(22) Filed: Jun. 10, 2014

(30) Foreign Application Priority Data
Jan. 22, 2014 (KR) 10-2014-0007785

(51) Int. Cl. G06F 3/041; G06F 1/16

(52) U.S. Cl. CPC G06F 3/0412; G06F 3/041; G06F 1/16; G06F 2203/04111; G06F 2203/04112

(57) ABSTRACT

Embodiments of the invention provide a touch sensor, including a base substrate, first electrode patterns formed on one surface of the base substrate in parallel with each other, and second electrode patterns formed on the other surface of the base substrate to intersect with a direction in which the first electrode patterns are formed. The first electrode patterns are formed in patterns corresponding to the second electrode patterns to cover the second electrode patterns in a region in which the first electrode patterns and the second electrode patterns intersect each other.

### CROSS REFERENCE TO RELATED APPLICATION

This application claims the benefit of and priority under 35 U.S.C. §119 to Korean Patent Application No. KR 10-2014-0007785, entitled “TOUCH SENSOR,” filed on Jan. 22, 2014, which is hereby incorporated by reference in its entirety into this application.

### BACKGROUND

1. Field of the Invention

The present invention relates to a touch sensor.

2. Description of the Related Art

With the development of computers using a digital technology, computer-aided devices have also been developed, and personal computers, portable transmitters and other personal exclusive information processors execute processing of texts and graphics using a variety of input devices such as a keyboard and a mouse.

With the rapid advancement of an information-oriented society, the use of computers has gradually been expanded; however, it is difficult to efficiently operate products using only a keyboard and a mouse, which currently serve as input devices. Therefore, the necessity for a device, which has a simple configuration and less malfunction and is configured for anyone to easily input information, has been increased.

In addition, technologies for input devices have progressed toward techniques related to high reliability, durability, innovation, designing and processing, and the like, in addition to satisfying general functions. To this end, a touch sensor has been developed as input devices capable of inputting information such as texts and graphics.

This touch sensor is equipment, which is mounted on a display surface of a display, such as an electronic organizer, a flat panel display device including a liquid crystal display (LCD) device, a plasma display panel (PDP), an electroluminescence (El), as non-limiting examples, or a cathode ray tube (CRT) to thereby be used to allow a user to select desired information while viewing the display.

In addition, a type of the touch sensor may be classified into a resistive type, a capacitive type, an electro-magnetic type, a surface acoustic wave (SAW) type, and an infrared type, as non-limiting examples. These various types of touch sensors have been adapted for electronic products in consideration of a signal amplification problem, a resolution difference, a difficulty of designing and processing technology, optical characteristics, electrical characteristics, mechanical characteristics, anti-environment characteristics, input characteristics, durability, and economic efficiency. Currently, the resistive touch sensor and the capacitive touch sensor have been used in a wide range of fields.

Meanwhile, in the touch sensor of conventional art, for example, as described in Japanese Patent Publication JP2011-175967, research to form an electrode pattern using metal has been actively conducted. In the case of forming the electrode pattern using metal, electrical conductivity is excellent and a supply and demand is smooth, but in the case of forming the electrode pattern using metal (e.g., Cu), there is a problem in that the electrode pattern may be visualized due to opacity of the metal electrode used for conductivity.

### SUMMARY

Accordingly, embodiments of the invention have been made in an effort to provide a touch sensor capable of reducing visibility of an electrode pattern by overlapping first and second electrode patterns each other in a region in which the first and second electrode patterns formed on one surface or the other surface of the base substrate intersect each other.

According to an embodiment of the invention, there is provided a touch sensor including a base substrate, first electrode patterns formed on one surface of the base substrate in parallel with each other, and second electrode patterns formed on the other surface of the base substrate to intersect with a direction in which the plurality of first electrode patterns are formed. The first electrode patterns are formed in patterns corresponding to the second electrode patterns to cover the second electrode patterns in a region in which the first electrode patterns and the second electrode patterns intersect each other.

According to an embodiment, the first electrode patterns include a first mesh pattern formed of a first metal wire, the second electrode patterns include a second mesh pattern formed of a second metal wire, and the first metal wire is formed in a pattern corresponding to the second metal wire to cover the second metal wire in the intersecting region.

According to an embodiment, a width W1 of the first metal wire is equal to or larger than a width W2 of the second metal wire.

According to an embodiment, a width W1 of the first metal wire and a width W2 of the second metal wire are represented by W1≧W2+2×tan θ×D, where D is a vertical distance in a thickness direction between the first metal wire and the second metal wire and θ represents an angle formed by the vertical distance D and a line L connecting between one end in a width direction of the first metal wire and one end in a width direction of the corresponding second metal wire.

According to an embodiment, the first and second mesh patterns are each made of copper (Cu), aluminum (Al), gold (Au), silver (Ag), titanium (Ti), palladium (Pd), chromium (Cr), nickel (Ni), or a combination thereof.

According to an embodiment, the touch sensor further includes a display module, which is bonded to the second electrode pattern and is any one of a LCD, a CRT, a LED, and an OLED.

According to another embodiment of the invention, there is provided a touch sensor including first electrode patterns formed on one surface of a first base substrate in parallel with each other, and second electrode patterns formed on one surface of the second base substrate in parallel with a direction in which the second electrode patterns intersect with the first electrode patterns. The first electrode patterns are formed in patterns corresponding to the second electrode patterns to cover the second electrode patterns in a region in which the first electrode patterns and the second electrode patterns intersect each other.

According to an embodiment, the first electrode patterns are a first mesh pattern formed of a first metal wire, the second electrode pattern are a second mesh pattern formed of a second metal wire, and the first metal wire is formed in a pattern corresponding to the second metal wire to cover the second metal wire, in the intersecting region.

According to an embodiment, a width W1 of the first metal wire is equal to or larger than a width W2 of the second metal wire.

According to an embodiment, a width W1 of the first metal wire and a width W2 of the second metal wire is represented by W1>W2+2×tan θ×D, where D is a vertical distance in a thickness direction between the first metal wire and the second metal wire, and θ represents an angle formed by the vertical distance D and a line L connecting between one end in a width direction of the first metal wire and one end in a width direction of the corresponding second metal wire.

According to an embodiment, the first and second mesh patterns are each made of copper (Cu), aluminum (Al), gold (Au), silver (Ag), titanium (Ti), palladium (Pd), chromium (Cr), nickel (Ni), or a combination thereof.

According to an embodiment, the touch sensor further includes a display module, which is bonded to the second electrode pattern and is any one of a LCD, a CRT, a LED, and an OLED.

Various objects, advantages and features of the invention will become apparent from the following description of embodiments with reference to the accompanying drawings.

### BRIEF DESCRIPTION OF DRAWINGS

These and other features, aspects, and advantages of the invention are better understood with regard to the following Detailed Description, appended Claims, and accompanying Figures. It is to be noted, however, that the Figures illustrate only various embodiments of the invention and are therefore not to be considered limiting of the invention's scope as it may include other effective embodiments as well.

FIG. 1 is a perspective view of a touch sensor according to an embodiment of the invention.

FIG. 2 is a cross-sectional view of a touch sensor according to an embodiment of the invention taken along the line H-H′ of FIG. 1.

FIG. 3 is a cross-sectional view of a touch sensor according to another embodiment of the invention taken along the line H-H′ of FIG. 1.

FIG. 4 is a plan view of an electrode pattern according to an embodiment of the invention.

FIG. 5 is a diagram illustrating first and second electrode patterns of portion A in cross-sectional view of the electrode pattern taken along the line H-H′ of FIG. 4 according to an embodiment of the invention.

### DETAILED DESCRIPTION

Advantages and features of the present invention and methods of accomplishing the same will be apparent by referring to embodiments described below in detail in connection with the accompanying drawings. However, the present invention is not limited to the embodiments disclosed below and may be implemented in various different forms. The embodiments are provided only for completing the disclosure of the present invention and for fully representing the scope of the present invention to those skilled in the art.

For simplicity and clarity of illustration, the drawing figures illustrate the general manner of construction, and descriptions and details of well-known features and techniques may be omitted to avoid unnecessarily obscuring the discussion of the described embodiments of the invention. Additionally, elements in the drawing figures are not necessarily drawn to scale. For example, the dimensions of some of the elements in the figures may be exaggerated relative to other elements to help improve understanding of embodiments of the present invention. Like reference numerals refer to like elements throughout the specification.

Hereinafter, a touch sensor according to various embodiments of the invention will be described in detail with reference to the attached drawings.

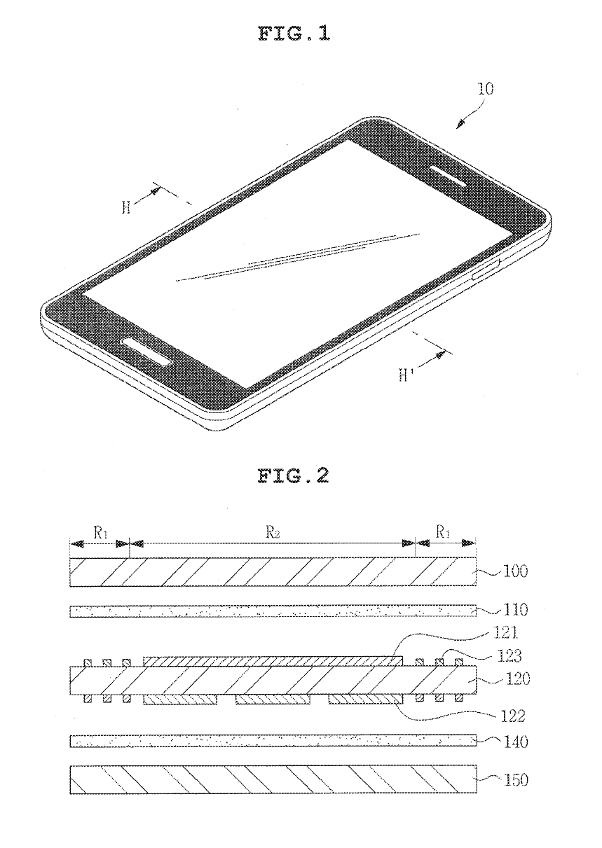

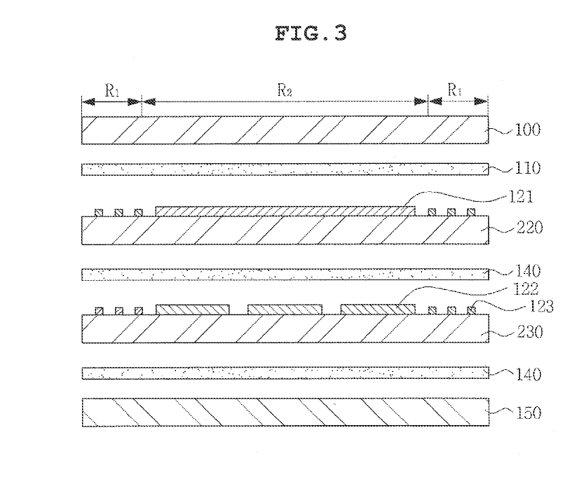

FIG. 1 is a perspective view of a touch sensor according to an embodiment of the invention, FIG. 2 is a cross-sectional view of a touch sensor according to an embodiment of the invention taken along the line H-H′ of FIG. 1, and FIG. 3 is a cross-sectional view of a touch sensor according to another embodiment of the invention taken along the line H-H′ of FIG. 1.

As illustrated in FIGS. 1 and 2, a touch sensor 10 according to an embodiment of the invention includes a window substrate 100, a base substrate 120, and first and second electrode patterns 121 and 122, which are each formed on both surfaces of the base substrate 120, in which a display module or display 150 for displaying an output value in response to an input of a user by the touch sensor is bonded on the second electrode pattern 122 formed on the other surface of the base substrate 120 by, for example, adhesive layers 110 and 140.

According to an embodiment, the window substrate 100 includes a central region R1 and an edge region R2, which is formed to enclose the central region R1 and is disposed at an outermost portion of the touch sensor 10 to receive a user's touch and is made, for example, of tempered glass to serve as a passivation layer, and a bezel part (not illustrated) and the electrode patterns 121 and 122 are formed on a rear surface of the window substrate 100, and therefore a surface treating layer (not illustrated) is formed by performing, for example, high frequency treatment or primer treatment on the rear surface of the window substrate 100 to improve an adhesion between the window substrate 100 and the bezel part (not illustrated) or the electrode patterns 121 and 122.

According to an embodiment, the base substrate 120 is made of any material which has transparency and output an image of the display module or display 150 without being particularly limited as a material, which has a predetermined strength, but is made, for example, of polyethylene terephthalate (PET), polycarbonate (PC), poly methyl methacrylate (PMMA), polyethylene naphthalate (PEN), polyethersulpon (PES), cyclic olefin polymer (COC), triacetylcellulose (TAC) film, polyvinyl alcohol (PVA) film, polyimide (PI) film, polystyrene (PS), biaxially stretched polystyrene (K resin containing biaxially oriented PS; BOPS), glass, or tempered glass. Further, one surface of the base substrate 120 is formed with the electrode patterns 121 and 122, and therefore the surface treating layer is formed by performing one surface of the base substrate 120 with, for example, high frequency treatment, primer treatment, to improve the adhesion between the base substrate 120 and the electrode patterns 121 and 122.

According to an embodiment, (1) in the touch sensor 10 according to an embodiment of the invention (see FIG. 2), the first electrode patterns 121 are formed on an upper surface of the base substrate 120 in parallel with each other and the second electrode patterns 122 are formed on a lower surface of the base substrate 120 to intersect with a direction in which the first electrode patterns 121 are formed and (2) in the touch sensor 10 according to another embodiment of the invention (see FIG. 3), the first electrode patterns 121 are formed on one surface of the base substrate in parallel with each other and the second electrode patterns 122 are formed on one surface of the second base substrate 120 in parallel with each other in a direction in which the second electrode patterns 122 intersect the first electrode patterns 121.

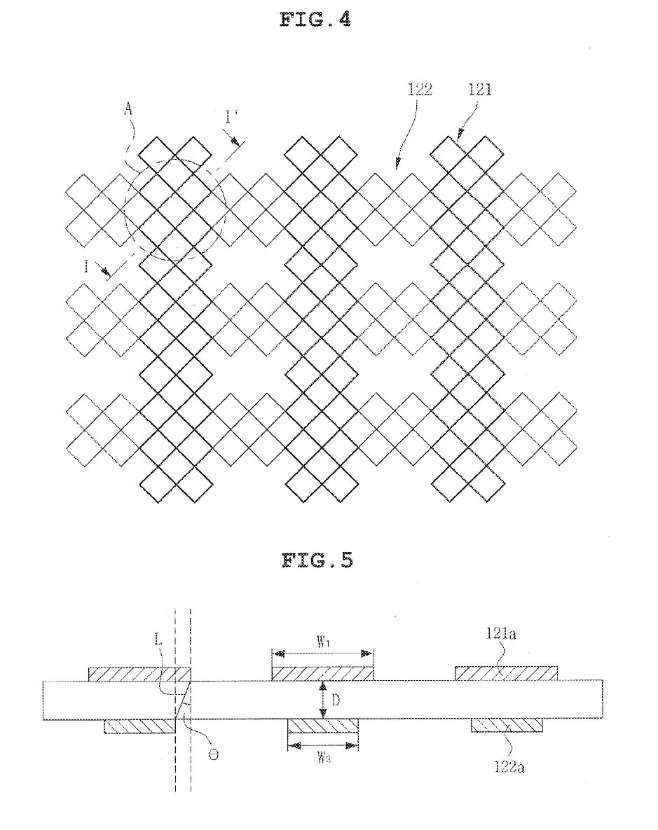

Further, as shown in FIG. 4, in a region A in which the first electrode pattern 121 and the second electrode pattern 122 intersect the first electrode pattern 121 and the second electrode pattern 122, the first electrode pattern 121 is formed in a pattern corresponding to the second electrode pattern 122 to cover the second electrode pattern 122.

Further, the first electrode pattern 121 and the second electrode pattern 122 are illustrated as a bar pattern, but shapes and structures of the first and second electrode patterns 121 and 122 according to various embodiments of the invention are not particularly limited, and the first and second electrode patterns 121 and 122, according to at least one embodiment, are formed in first and second mesh patterns, which are formed of first and second metal wires 121a and 122a and the mesh pattern has polygonal shapes, such as a quadrangular shape, a triangular shape, and a diamond shape, but is not limited to a particular shape (see FIG. 5).

With respect to FIG. 5, a width W1 of the first metal wire 121a configuring the first electrode patterns 121 is formed to be equal to or larger than a width W2 of the second metal wire 122a and the first and second electrode patterns 121 and 122 are formed in the mesh pattern, which is made of copper (Cu), aluminum (Al), gold (Au), silver (Ag), titanium (Ti), palladium (Pd), chromium (Cr), nickel (Ni), or a combination thereof.

As a method of forming the first and second electrode patterns 121 and 122, a dry process, a wet process, or a direct patterning process is used. Here, the dry process includes, for example, sputtering and evaporation, the wet process includes, for example, dip coating, spin coating, roll coating, and spray coating, and the direct patterning process includes, for example, screen printing, gravure printing, and inkjet printing.

According to an embodiment, adhesive layers 110 and 140 serve to bond between components of the touch sensor 10 and are made of a transparent material, for example, an optical clear adhesive (OCA), so that an image output through the display module 150 is recognized by the user without any hindrance.

According to an embodiment, the display module or display 150, which is bonded to one surface of the touch sensor 10 through the adhesive layers 110 and 140 and is a display device visually outputting data on a screen is mainly a cathode ray tube (CRT), a liquid crystal display (LCD), a plasma display panel (PDP), a light emitting diode (LED), and an organic light emitting diode (OLED), but is not necessarily limited thereto.

Hereinafter, a formation structure between the first and second metal wires configuring the first and second electrode patterns in the touch sensor according to various embodiments of the invention will be described in more detail with reference to FIGS. 4 and 5.

FIG. 4 is a plan view of an electrode pattern according to an embodiment of the invention, and FIG. 5 is a diagram illustrating first and second electrode patterns of portion A in cross-sectional view of the electrode pattern taken along the line H-H′ of FIG. 4 according to an embodiment of the invention.

Generally, the first electrode pattern 121 of the touch sensor 10 is formed in a first mesh pattern formed of the first metal wire 121a and the second electrode pattern 122 thereof is formed in a second mesh pattern which is formed of the second metal wire 122a, and the mesh pattern has polygonal shapes, such as a quadrangular shape, a triangular shape, and a diamond shape, but is not limited to a particular shape.

However, as the mesh patterns form the first and second electrode patterns 121 and 122 using the opaque first and second metal wires 121a and 122a, the first and second electrode patterns 121 and 122 are visualized by the user of the touch sensor 10. In particular, in the structure in which the first and second electrode patterns 121 and 122 are formed on both surfaces of the base substrate 120, the first electrode pattern 121 formed on the upper surface of the base substrate 120 has the reduced visibility from the outside by blackening, but in the case of the second electrode pattern 122 formed on the lower surface of the base substrate 120, a bonded portion with the base substrate 120 is not subjected to the blackening, and therefore an opaque metal color is visualized.

Therefore, there is a need to reduce the visibility of the first and second electrode patterns 121 and 122 while forming the first and second electrode patterns 121 and 122 including the mesh pattern in a fine pattern. Further, when the first and second electrode patterns 210 and 220 are formed using a metallic wire, the first and second electrode patterns 210 and 220 are easily corroded due to a potential difference or since they are connected to electrode wirings connecting between a positive pole and a negative pole and thus have a problem of durability, for example.

As illustrated in FIG. 4, the touch sensor 10 according to an embodiment of the invention has a structure in which the first and second patterns 121 and 122 are formed on both surfaces of the base substrate 120 in the mesh patterns formed of the opaque first and second metal wires 121a and 122a, and therefore the width W1 of the first metal wire 121a are formed to be equal to or larger than the width W2 of the second metal wire 122a, so that the first metal pattern 121a is be formed in a pattern corresponding to the second metal pattern 122a to cover the second metal wire in the region A in which the first and second electrode patterns 121 and 122 intersect each other.

In detail, as illustrated in FIG. 5, in the first electrode pattern 121 formed on the upper surface of the base substrate 120 and the second pattern 122 formed on the lower surface of the base substrate 120, the width W1 of the first metal wire 121a is formed within a range satisfying the following Equation, in the relationship among the width W2 of the second metal wire, a vertical distance D in a thickness direction between the first metal wire 121a and the second metal wire 122a, and an angle θ formed by the vertical distance D and a line L connecting between one end in a width direction of the first metal wire 121a and one end in a width direction of the corresponding second metal wire 122a.

W1>W2+2×tan θ×D [Equation]

Therefore, the touch sensor 10 according to an embodiment of the invention has (1) a structure in which the first electrode patterns 121 is formed on the upper surface of the base substrate 120 in parallel with each other and the second electrode patterns 122 is formed on the lower surface of the base substrate 120 to intersect with the direction in which the first electrode pattern 121 are formed, and (2) a structure in which the first electrode patterns 121 are formed on one surface of the first base substrate in parallel with each other and the second electrode patterns 122 are formed on one surface of the second base substrate 120 in parallel with each other in a direction in which the second electrode patterns 122 intersect the first electrode patterns in which the first and second mesh patterns configured of the first and second metal wires 121 and 122a of the first and second electrode patterns 121 and 122 are formed to overlap each other in the same form and the width W1 of the first metal wire 121a is formed to be equal to or larger than the width W2 of the second metal wire 122a, such that the opaque metal color of the second metal wire 122a is covered with the first metal wire 121a, thereby reducing the visibility of the second electrode pattern 122 and simplifying the manufacturing process of the touch sensor due to the removal of the blackening process, and the like.

As set forth above, for the touch sensor according to various embodiments of the invention, the first metal wire configuring the first electrode pattern and the second metal wire configuring the second electrode pattern are formed to overlap each other so as not to be visualized from the outside in the region in which the first electrode pattern formed on the upper surface of the base substrate and the second electrode pattern formed on the lower surface thereof intersect each other, thereby reducing the visibility of the second electrode pattern made of the opaque metal (e.g., Cu).

Further, the first and second electrode patterns are formed in the mesh patterns, which are formed of the metal wires and have the same shape as each other, in the region in which the first and second electrode patterns intersect each other and the line width W1 of the first metal wire configuring the first electrode pattern is equal to or larger than the line width W2 of the second metal wire configuring the second electrode pattern, thereby improving the visibility of the second metal wire from the outside.

In addition, due to the structure in which the width of the first metal wire of the first electrode pattern is formed to be equal to or larger than that of the second metal wire of the second electrode pattern, the blackening processing for reducing the visibility of the metal wire, for example, made of the opaque metal, is omitted, thereby simplifying the manufacturing process of the touch sensor.

Terms used herein are provided to explain embodiments, not limiting the present invention. Throughout this specification, the singular form includes the plural form unless the context clearly indicates otherwise. When terms “comprises” and/or “comprising” used herein do not preclude existence and addition of another component, step, operation and/or device, in addition to the above-mentioned component, step, operation and/or device.

Embodiments of the present invention may suitably comprise, consist or consist essentially of the elements disclosed and may be practiced in the absence of an element not disclosed. For example, it can be recognized by those skilled in the art that certain steps can be combined into a single step.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe the best method he or she knows for carrying out the invention.

The terms “first,” “second,” “third,” “fourth.” and the like in the description and in the claims, if any, are used for distinguishing between similar elements and not necessarily for describing a particular sequential or chronological order. It is to be understood that the terms so used are interchangeable under appropriate circumstances such that the embodiments of the invention described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The singular forms “a,” “an,” and “the” include plural referents, unless the context clearly dictates otherwise.

As used herein and in the appended claims, the words “comprise,” “has,” and “include” and all grammatical variations thereof are each intended to have an open, non-limiting meaning that does not exclude additional elements or steps.

As used herein, the terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein. The term “coupled,” as used herein, is defined as directly or indirectly connected in an electrical or non-electrical manner. Objects described herein as being “adjacent to” each other may be in physical contact with each other, in close proximity to each other, or in the same general region or area as each other, as appropriate for the context in which the phrase is used. Occurrences of the phrase “according to an embodiment” herein do not necessarily all refer to the same embodiment.

Ranges may be expressed herein as from about one particular value, and/or to about another particular value. When such a range is expressed, it is to be understood that another embodiment is from the one particular value and/or to the other particular value, along with all combinations within said range.

Although the present invention has been described in detail, it should be understood that various changes, substitutions, and alterations can be made hereupon without departing from the principle and scope of the invention. Accordingly, the scope of the present invention should be determined by the following claims and their appropriate legal equivalents.

What is claimed is:

1. A touch sensor, comprising:
a base substrate;
first electrode patterns formed on one surface of the base substrate in parallel with each other, and
second electrode patterns formed on the other surface of the base substrate to intersect with a direction in which the first electrode patterns are formed,
wherein the first electrode patterns are formed in patterns corresponding to the second electrode patterns to cover the second electrode patterns in a region in which the first electrode patterns and the second electrode patterns intersect each other.

2. The touch sensor according to claim 1, wherein the first electrode patterns are a first mesh pattern formed of a first metal wire,
the second electrode patterns are a second mesh pattern formed of a second metal wire, and
the first metal wire is formed in a pattern corresponding to the second metal wire to cover the second metal wire in the intersecting region.

3. The touch sensor according to claim 2, wherein a width W1 of the first metal wire is equal to or larger than a width W2 of the second metal wire.

4. The touch sensor according to claim 2, wherein a width W1 of the first metal wire and a width W2 of the second metal wire are represented by the following Equation.
W1>W2+2×tan θ×D
wherein D is a vertical distance in a thickness direction between the first metal wire and the second metal wire, and θ represents an angle formed by the vertical distance D and a line L connecting between one end in a width direction of the first metal wire and one end in a width direction of the corresponding second metal wire.

5. The touch sensor according to claim 2, wherein the first and second mesh patterns are each made of copper (Cu), aluminum (Al), gold (Au), silver (Ag), titanium (Ti), palladium (Pd), chromium (Cr), nickel (Ni), or a combination thereof.

6. The touch sensor according to claim 1, further comprising:
a display module which is bonded to the second electrode pattern and is any one of a LCD, a CRT, a LED, and an OLED.

7. A touch sensor, comprising:
first electrode patterns formed on one surface of a first base substrate in parallel with each other, and
second electrode patterns formed on one surface of a second base substrate in parallel with a direction in which the second electrode patterns intersect with the first electrode patterns,
wherein the first electrode patterns are formed in patterns corresponding to the second electrode patterns to cover the second electrode patterns, in a region in which the first electrode patterns and the second electrode patterns intersect each other.

8. The touch sensor according to claim 7, wherein the first electrode pattern is a first mesh pattern formed of a first metal wire,
the second electrode pattern is a second mesh pattern formed of a second metal wire, and
the first metal wire is formed in a pattern corresponding to the second metal wire to cover the second metal wire in the intersecting region.

9. The touch sensor according to claim 8, wherein a width W1 of the first metal wire is equal to or larger than a width W2 of the second metal wire.

10. The touch sensor according to claim 8, wherein a width W1 of the first metal wire and a width W2 of the second metal wire are represented by the following Equation:
W1≧W2+2×tan θ×D
wherein D is a vertical distance in a thickness direction between the first metal wire and the second metal wire, and θ represents an angle formed by the vertical distance D and a line L connecting between one end in a width direction of the first metal wire and one end in a width direction of the corresponding second metal wire.

11. The touch sensor according to claim 8, wherein the first and second mesh patterns are each made of copper (Cu), aluminum (Al), gold (Au), silver (Ag), titanium (Ti), palladium (Pd), chromium (Cr), nickel (Ni), or a combination thereof.

12. The touch sensor according to claim 7, further comprising:
a display module which is bonded to the second electrode pattern and is any one of a LCD, a CRT, LED, and an OLED.
